(19) United States
(12) Patent Application Publication
(10) Pub. No.: US 2008/0090067 A1
(43) Pub. Date: Apr. 17, 2008

(54) MANUFACTURED DOOR

(76) Inventor: ORLANDO DE LA ROSA, EL TREBOL TEPOTZOTLAN (MX)

Correspondence Address: ROBERT M. SCHWARTZ, P.A., P.O. BOX 221470, HOLLYWOOD, FL, 33022, US

(21) Appl. No.: 11/872,189

(22) Filed: Oct. 15, 2007

Related U.S. Application Data
(60) Provisional application No. 60/851,445, filed on Oct. 13, 2006.

(51) Int. Cl. B32B 3/26

(52) U.S. Cl. 428/304.4

(57) ABSTRACT

The present invention is a manufactured door with a frame made from extruded PVC that is machined to tolerance and having a surface of extruded ABS laminate that is attached to the frame.

### INDEX TO RELATED APPLICATIONS

This application claims the benefit of U.S. Provisional Patent Application Ser. No. 60/851,445, filed Oct. 13, 2006, the disclosure of which is incorporated herein by reference in its entirety.

### BRIEF SUMMARY OF THE INVENTION

In one embodiment the present invention relates to an improved manufactured door comprising or consisting of:
(a) an interior region comprising a frame of extruded PVC;
(b) a face, whereby said face is extruded ABS laminate; and
(c) a jamb, whereby said jamb supports said door by means of butts.

Said interior frame may be formed by several portions that are attached by suitable adhesive as is commonly known in the art. Said face further comprises an ABS laminate extruded onto a backing of PVC. Said interior region may be filled with foam or other suitable filler. The density of said interior region is less than the density of said ABS laminate extruded onto a backing of PVC. In one embodiment, the manufactured door has a density of said interior frame between 0.5-1.5 g/cm³. The density of said face may be between 1.2-3.0 g/cm³. Additionally, the ratio of the density of said interior region to the density of said ABS laminate extruded onto a backing of PVC is between 1:2 and 1:4.

In one embodiment, the inner frame that gives the complete structure of the door, is made of a square profile, extruded in foam P.V.C., which afterwards is passed through a machine in order to smooth down two sides of the profile with millimetric precision in such a way that obtains an accommodation for the two covers of the door manufactured in sheets of Acrylonitrile Butadiene Styrene (ABS) with a decorative film of P.V.C.

In a preferred embodiment, the cut precision provides that in gluing the sheets with the smoothed down section of the profile, it is not possible to distinguish the separation between the frame and the sheet, which gives uniformity to the product and a superior appearance. Upon contact, there is no unevenness between the foam profile and the sheet of plastic.

The film is bound during the extrusion process of the sheet by means of heat, which allows for a complete anchorage of the film of P.V.C. to the sheet of plastic.

The surface of the profile in P.V.C. is smooth and hard unlike the inside which is foam. The hardness of the surface is greater than that of the center of the profile; the external appearance is grained in imitation of wood. (A density of 1.7 g/cm³ for the exterior and 0.7 g/cm³ for the interior).

Generally, a foam P.V.C. profile does not have a hard and smooth external surface. The door of the present invention has these characteristics and a wood appearance is achieved by means of a special pigmentation process.

In a preferred embodiment:

The frame is extruded from PVC. It is machined to give a flat surface with a tolerance of ±0.25-0.5 mm. Four sections, each cut at a 45 degree angle are assembled using suitable adhesive.

Exterior portion is prepared by extruding Acrylonitrile Butadiene Styrene (ABS) sheets and by heat lamination and pressure, a PVC sheet is attached to the ABS sheet.

The exterior ABS sheets are cut to size and are attached to the frame with a suitable adhesive.

Polyurethane foam is injected into the interior portion of the as a filler.

### BRIEF DESCRIPTION OF THE DRAWINGS

FIG. 1 is a front view of the door of the present invention.

FIG. 2 is a cross section view from FIG. 1 of the interior portion of the door.

FIG. 3 is a cross-section of the laminate assembly applied to the front and rear faces of the door.

### DETAILED DESCRIPTION OF THE PREFERRED EMBODIMENTS

The door 10 of the present invention has an exterior decorative surface or face 31 formed of extruded ABS that is attached to a PVC backing 13 by heat lamination and pressure. Typically, face 31 is a decorative or ornamental surface. However, face 31 may also be a surface suitable for receiving paint, wallpaper, or any other desired design features.

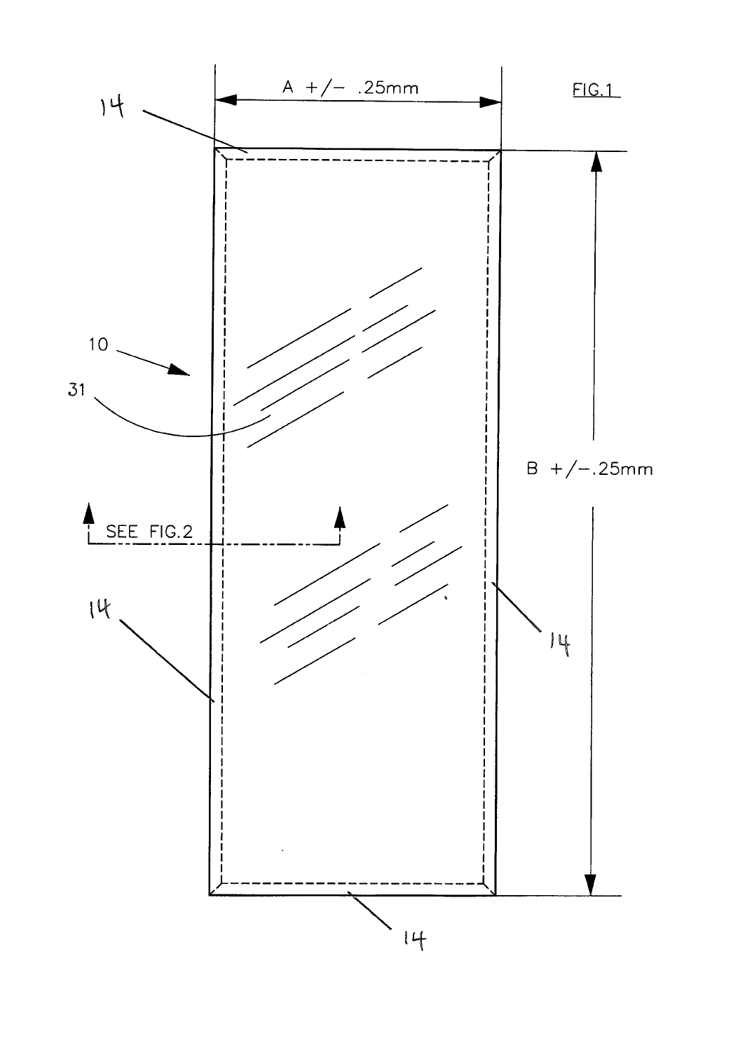

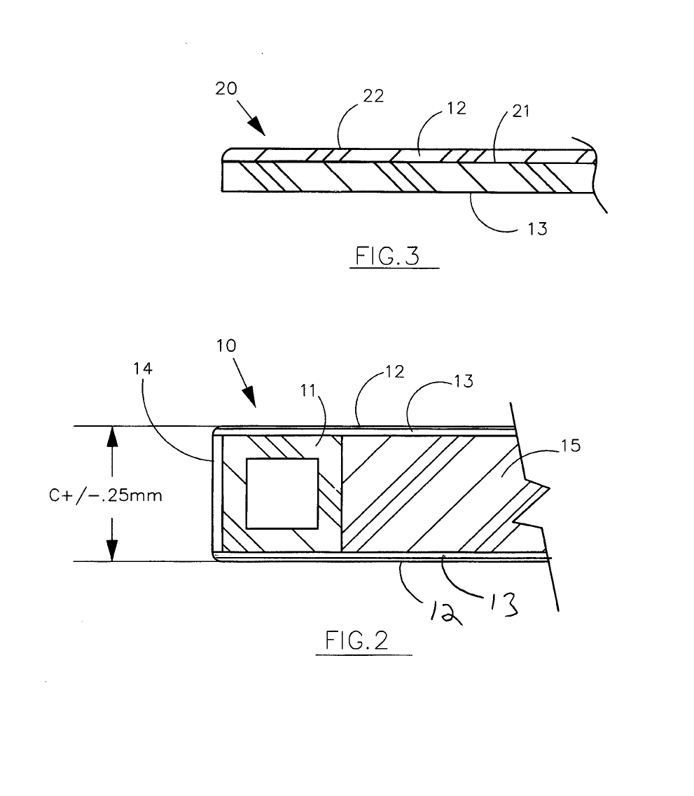

FIG. 2 is a cross-section of door 10 along the line as indicated in FIG. 1. Door 10 has an interior frame 11 of extruded PVC. The frame 11 is machined such that each horizontal surface has a tolerance of ±0.25 mm. Door 10 also includes a butt 14 on the peripheral door regions that is secured by any acceptable manner as is commonly known in the art.

As shown in FIG. 3, which is an expanded cross section of ABS laminate 12 and PVC backing 13 from FIG. 2, ABS laminate 12 includes laminate assembly 20 that has an outer decorative surface 22. ABS laminate 12 is attached to a PVC backing 13 by heat lamination and pressure at interface 21.

When laminate assembly 20 is attached to the front and rear face of door 10, and subsequent butts 14 are attached, the resulting interior cavity bound by ABS laminate 12 attached to laminate backing 13 on the inner and outer potions of door 10 and corresponding butts 14 on each of the four edges filled with foam 15.

While the invention has been described in its preferred form or embodiment with some degree of particularity, it is understood that this description has been given only by way of example and that numerous changes in the details of construction, fabrication, and use, including the combination and arrangement of parts, may be made without departing from the spirit and scope of the invention.

I claim:

1. An improved manufactured door comprising:
a. an interior region comprising a frame of extruded PVC;
b. a face, whereby said face is extruded ABS laminate; and
c. a jamb, whereby said jamb supports said door by means of butts.

2. The manufactured door of claim 1 wherein said interior frame

3. The manufactured door of claim 1 wherein said face further comprises an ABS laminate extruded onto a backing of PVC.

4. The manufactured door of claim 1 wherein said interior region is filled with foam.

5. The manufactured door of claim 1 wherein the density of said interior region is less than the density of said ABS laminate extruded onto a backing of PVC.

6. The manufactured door of claim 1 wherein the density of said interior frame is between 0.5-1.5 g/cm³.

7. The manufactured door of claim 1 wherein the density of said face is between 1.2-3.0 g/cm³.

8. The manufactured door of claim 1 wherein the ratio of the density of said interior region to the density of said ABS laminate extruded onto a backing of PVC is between 1:2 and 1:4.

9. A method of manufacturing a door comprising the steps of:
a. extruding an interior region of a door frame from PVC;
b. extruding exterior face regions from ABS laminate;
c. machining the extruded interior region such that the horizontal plane has a variable tolerance of less than about ±0.5 mm;
d. securing the extruded exterior face regions to the extruded interior region without completely enclosing an interior cavity of the door formed by the securing of exterior face regions;
e. filling the interior cavity with a foam;
f. securing an additional exterior face region to the extruded interior region to completely enclose the interior cavity of the door;
g. attaching the door to a jamb, whereby said jamb supports said door by means of butts.

10. The method of claim 9 wherein four extruded interior region sections are each cut at a 45 degree angle are assembled into a rectangular configuration using a suitable adhesive.

11. The method of claim 9 wherein the exterior face regions extruded from ABS laminate are attached to a PVC backing by heat lamination and pressure.

12. The method of claim 9 wherein the foam is polyurethane foam.
